(19) United States
(12) Patent Application Publication
(10) Pub. No.: US 2026/0120212 A1
(43) Pub. Date: Apr. 30, 2026

(54) EDUCATIONAL STANDARDS ALIGNMENT SYSTEM FOR MAPPING AN INPUT SENTENCE AGAINST EDUCATIONAL STANDARDS USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Joshua Singer, Austin, TX (US); Cameron Kelley, Franklin, TN (US)

(73) Assignee: 2hr Learning, Inc., Austin, TX (US)

(21) Appl. No.: 19/367,669

(22) Filed: Oct. 23, 2025

Related U.S. Application Data
(60) Provisional application No. 63/711,129, filed on Oct. 23, 2024.
(60) Provisional application No. 63/711,132, filed on Oct. 23, 2024.

(51) Int. Cl. G06Q 50/20; G06F 40/284; G06F 40/30

(52) U.S. Cl. CPC G06Q 50/205; G06F 40/284; G06F 40/30

(57) ABSTRACT

An educational standards alignment system and process automatically evaluate whether an input sentence aligns with predefined educational standards is disclosed. The educational standards alignment system receives an input sentence from a database that stores sentences associated with various educational standards. The system accesses a mapping function library, which contains multiple sets of functions designed to check the sentence against individual educational standards. Each set of functions can include programmatic checks, large language model (AI) checks, and natural language processing (NLP) checks. The functions are called and executed to determine if the input sentence aligns with a specific language standard. If confirmed, the sentence is tagged accordingly and passed for further evaluation against additional standards. The output is a list of educational standards that the input sentence matches, allowing for efficient, scalable, and automated tagging of sentences across a wide range of educational standards.

### CROSS-REFERENCE TO RELATED APPLICATION(S)

This application claims the benefit under 35 U.S.C. § 119 (e) and 37 C.F.R. § 1.78 of U.S. Provisional Application Nos. 63/711,129 and 63/711,132, which are incorporated by reference in their entireties.

### FIELD OF THE INVENTION

The present invention relates in general to the field of electronics, and more specifically to automate the selection of one or more functions to check if an input sentence gets tagged against an educational standard or not, particularly a language standard.

### BACKGROUND OF THE INVENTION

The Common Core State Standards (CCSS) are guidelines used to identify clear goals for students to achieve by studying English language arts and other subjects. The CCSS outlines what students from Grades K-12 should know. These standards encourage the integration of literacy skills across different subject areas. The CCSS are clear and specific for each grade level. These standards help teachers understand what content is appropriate for each grade level and how to structure lessons effectively. These standards support teachers in planning lessons that progressively build on students' skills. Further, these standards help students focus on developing critical thinking, analytical skills, and the ability to communicate effectively, which are crucial for college and career readiness.

The sentences are mapped against Common Core English Educational standards (CCSS) to ensure that educational materials align with the educational goals and help develop the curriculum. Traditionally, sentence tagging to determine the educational standard is a human-driven process. Typically, humans can interpret nuances, context, and complexities in language to ensure accurate tagging, however, individual interpretations of standards can vary, leading to inconsistent tagging. Although manual tagging provides tailored feedback by providing personalized insights, it is labor-intensive and can take considerable time, especially with large sentences.

Conventionally rule-based systems have been utilized for tagging processes. Although the rule-based system ensures consistent tagging across similar sentences, which enhances clarity in understanding the text, the rule-based systems struggle with ambiguity and variations in language. The rule-based systems require maintaining and updating the rules which can become a labor-intensive task that require higher costs.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an educational standards alignment system to check if an input sentence maps against one or more educational standards.

FIG. 2 depicts an educational standards alignment process to check if an input sentence maps against one or more educational standards.

FIG. 3 depicts an exemplary network environment in which the educational standards alignment system of FIG. 1 and the educational standards alignment process of FIG. 2 may be practiced.

FIG. 4 depicts an exemplary computer system.

### DETAILED DESCRIPTION

An educational standards alignment system and method check if an input sentence maps against one or more educational standards, such as language standards. The educational standards alignment system automatically calls one or more functions to check if an input sentence maps against a language standard. The educational standards alignment system includes an educational standard mapping system that receives input sentences from a sentence database, operatively coupled to the educational standard mapping system. The sentence database stores a list of sentences each aligning with one or more educational standards. The educational standard mapping system accesses a mapping function library which includes one or more set of functions. Each set of function includes one or more functions to be executed to check mapping of the input sentence against an individual language standard. A function calling module integrated within the educational standard mapping system calls a first set of functions from the mapping function library to check the mapping of the input sentence with a first language standard from the one or more educational standards. The first set of functions include at least one or more of programmatic checks, AI checks, and NLP checks.

A function execution module integrated within the educational standard mapping system and operatively coupled to the function calling module executes the first set of functions to identify mapping of the input sentence with the first set of language standard. The input sentence is tagged against the corresponding first language standard if the executed functions confirm mapping of the input sentence with the first language standard. The input sentence is then passed for mapping against the next set of educational standards to generate an output sentence including list of educational standards against which the input sentence is mapped.

The educational standards alignment system offers a highly efficient, scalable, and automated solution for tagging educational standards by evaluating sentences based on programmatic checks, AI-based evaluations, and NLP techniques. The educational standards alignment system ensures accurate mapping of sentences with the corresponding educational standards, even for complex sentences. This hybrid approach enables real-time processing, allowing for rapid assessment of large datasets, which is especially beneficial in educational contexts where diverse sentence structures must be analyzed. Additionally, the educational standards alignment system utilizes large language models, AI tools, and programming checks that lowers operational costs while maintaining high accuracy. Beyond tagging, the educational standards alignment system facilitates content generation by providing guidelines on how to craft sentences that align with specific standards, improving the development of educational materials. It also enhances user evaluation by offering personalized feedback based on the tagged learning standards, helping users understand their strengths and areas for improvement, and guiding them in achieving better alignment with educational language benchmarks.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

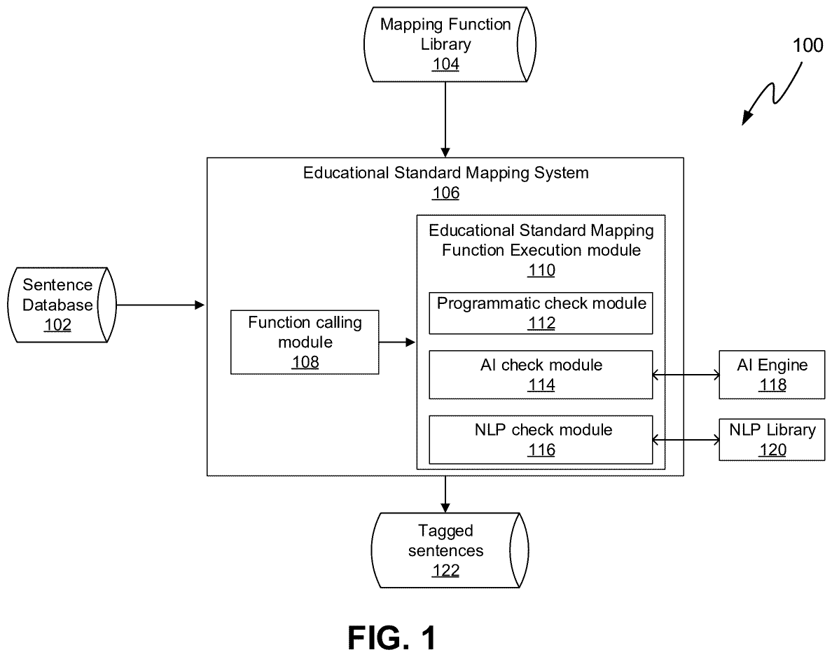

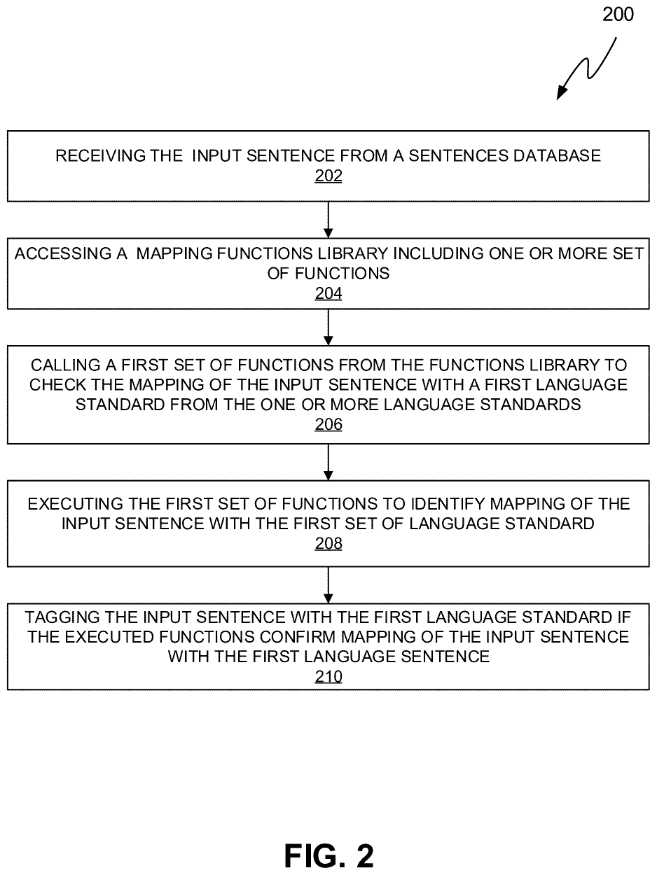

FIG. 1 depicts an educational standards alignment system 100 to check if an input sentence maps against one or more educational standards. FIG. 2 depicts an educational standards alignment process 200 to check if an input sentence maps against one or more educational standards, utilized by the educational standards alignment system 100.

In operation 202, an educational standard mapping system 106 receives an input sentence from a sentence database 102, that stores a list of sentences each aligning with one or more educational standards.

The educational standards alignment system 100 includes sentence database 102 that stores a list of sentences such that the sentence aligns with one or more educational standards. The sentences within the sentence database 102 follow a criterion that each sentence is aligned to at least one or more educational standards including but not limited to Common Core English Language (CCELA) Arts Standard. The Common Core English Language Arts (ELA) standards are a set of educational guidelines that outline the reading, writing, speaking, listening, and language skills students should master at each grade level (K-12). The CCELA standards emphasize critical thinking, evidence-based writing, and comprehension of complex texts to prepare students for college and careers.

The educational standard mapping system 106 is operatively coupled to access the sentence database 102. The educational standard mapping system 106 executes functions implemented in code to map the sentence against the individual educational standards.

The sentence database 102 stores a list of sentences. The list of sentences aligns with one or more educational standards. In at least one of the embodiments, the sentences are generated manually or by using any AI tool like Chat GPT. The sentences are a grammatically complete unit of thought that expresses an idea, typically containing a subject and a predicate. The generated sentences can convey statements, questions, commands, or exclamations, and varies in structure and complexity. The educational standards are guidelines within an educational curriculum that focus on effectively using and understanding language, including grammar, vocabulary, and conventions. The educational standards may include Common Core English Language Arts (CCELA) standards, World Languages Standards for California Public Schools, and so on. Sentences are integral to educational standards as they form the building blocks of effective communication. Mastering grammar and punctuation within sentences ensure clarity and precision in writing. Additionally, understanding various sentence structures enables students to express complex ideas and engage readers.

The educational standard mapping system 106 receives the input sentence from the list of sentences stored in the sentence database 102. The input sentence can be a simple, compound, sentence with abstract nouns, and others. For instance, the input sentence can be ‘The mice scampered across the wooden floor’, ‘The cat is sleeping on the couch’, The sun sets in the west and paints the sky with varying shades of orange and pink’, and various others. In at least one of the embodiments, only one input sentence is inputted to match the sentence to one or more educational standards. However, it should be noted that any number of sentences can be inputted to for parallel processing and mapping to relevant one or more educational standards.

In operation 204, the educational standard mapping system 106 accesses a mapping functions library 104 that includes one or more sets of functions. Each set of functions includes one or more functions to be executed to check the mapping of the input sentence against an individual language standard.

The educational standard mapping system 106 is operatively coupled to the mapping function library 104. The mapping function library 104 includes function specifications for various educational standards. The function specification includes details on one or more sets of functions for each language standard. The set of functions further encompasses a collection of one or more functions that work together to check the mapping of an input sentence against an individual language standard. The mapping function library 104 appends the definition of various educational standards. The definition includes a list of one or more functions to be executed to map the input sentence against a particular language standard. The mapping function library 104 stores the list of one or more functions in JSON file format. The JSON format is a text-based format that represents data as structured text. The JSON format is a machine-readable format that allows for efficient searching and retrieval. The mapping function library 104 includes multiple educational standards. Each language standard has a unique standard ID. For instance, there can be 80 standard IDs for various educational standards.

An exemplary JSON file stored in the mapping function library 104, including, the definition of various educational standards is shown below:

standard_id: Identifier for the standard (e.g., “L.3.1.c”).
description: A description of the standard.
functions_to_satisfy: Specifies whether all functions must pass (“all”) or
any one (“any”).
functions: A list of functions to apply, each with:
function_type: The name of the function to execute.
metadata: Additional data required by the function.
positive_cases: Example sentences that should pass the standard.
negative_cases: Example sentences that should fail the standard.

The JSON file contains definitions of educational standards that include different sections including ‘standard ID’, ‘description’, ‘functions to satisfy’, ‘functions’, ‘function type’, ‘metadata’, ‘positive cases’, and ‘negative cases.

The section ‘standard_id’ is the identifier of the corresponding language standard. For each language standard a unique standard ID is specified. The standard ID provides a unique identifier for the educational standards. Some of the standard IDs include L.3.1.b, L.3.1.c, L.3.1.d, L.3.1.h.1. The standard ID includes information about the grade level, subject area, and specific skill or knowledge to be assessed. For instance, for the standard ID L.3.1.c, ‘L’ represents ‘Language’, ‘3’ indicates the grade level, and ‘1.c’ specifies a particular aspect of language learning.

The section ‘description’ provides details of the standard ID. The details include specifications on what information is required for that standard ID. For instance, the ‘description’ of standard ID L.3.1.c provides details that a ‘sentence should include abstract nouns’, and the standard ID L.3.1.i.1 provides details that the ‘sentence should be simple’.

The section ‘functions_to_satisfy’ specifies if all functions are to be satisfied or if any only one of the functions is to be satisfied to validate the mapping of the input sentence to that of the language standard. For instance, if the ‘functions_to_satisfy’ require all the functions to execute the mapping of input sentences against the individual language standard, the sentence should pass all the criteria mentioned within the set of functions. If the ‘functions_to_satisfy’ requires ‘any’ of the functions to execute the mapping of input sentences against the individual language standard, the sentence should pass either one of the set of functions.

The section ‘functions’ specifies a set of functions. The section ‘functions’ further includes ‘function_type’, ‘metadata’, ‘positive_cases’, and ‘negative_cases’. The ‘function_type’ provides details on the name of one or more functions to be executed to check the mapping of the input sentence against an individual language standard. The ‘metadata’ refers to additional data required by one or more functions to execute the mapping of the input sentences. The ‘positive_cases’, and ‘negative_cases’ specifies a list of example standards that should pass and fail the standard.

The educational standard mapping system 106 accesses the JSON file from the mapping functions library 104. The input sentence is mapped against an individual language standard. One or more functions are executed to check the mapping of the input sentence against an individual language standard. The input sentence is mapped for each language standard.

For instance, the input sentence ‘The cat is sleeping on the couch’, It's true, isn't it? etc. will be mapped against various standards present in mapping function library 104 to ensure the alignment of the input sentence with various educational standards.

In operation 206, a function calling module 108 calls a first set of functions from the mapping function library 104 to check the mapping of the input sentence with a first language standard from the one or more educational standards. An educational standard mapping function module 110 integrated within the educational standard mapping system 106 utilizes the first set of functions including at least one or more of programmatic checks, AI checks, and NLP checks.

The function calling module 108 is integrated into the educational standard mapping system 106 and is responsible for calling the first set of functions. The function calling module calls the first set of functions from the mapping function library 104 to check the mapping of the input sentence with the first language standard. The first language standard typically refers to the first language standard to which the input sentence will be mapped. For instance, the input sentence will be mapped against the language standard with the standard ID ‘L.3.1.c’. This standard ID will be the first language standard. The input sentence should satisfy all the functions to be mapped against that standard. The input sentence is mapped against all the educational standards in the mapping function library 104.

For each language standard, there exist multiple functions that are to be executed to map the input sentence. The function calling module 108 calls the first set of functions based on the description in the JSON file for each language standard.

The function calling module 108 calls the first set of functions from the mapping function library 104 and involves a systematic approach to evaluate whether the input sentence aligns with a particular language standard. The function calling module 108 first identifies a specific set of functions from the mapping function library 104 that are associated with the language standard. This set of functions include three main types of checks, namely, but not limited to, programmatic checks, artificial intelligence (AI) checks, and NLP (Natural Language Processing) checks. Each of these checks is performed using dedicated modules designed to handle their respective operations, namely, a programmatic check module 112, an AI check module 114, and an NLP check module 116 respectively.

The programming check module 112 is responsible for executing pre-defined rules or logic to determine if the input sentence meets the criteria of the language standard. To perform these checks, the programming check module 112 calls programs written in languages such as Java, Python, and so on. These programs can include rules like regular expressions, string manipulations, or grammar parsers that help identify specific patterns, punctuation, or structures in the input sentence. For example, a programmatic check might validate if a sentence correctly uses a comma before a conjunction or follows a specific syntactic pattern.

The function-calling module 108 calls programmatic checks via, the programmatic check module 112 that automatically checks whether the input sentence contains the function or not. For instance, the input sentence ‘My childhood was filled with sunny days and laughter’ is first compared against the language standard with the standard ID ‘L.3.1.c’. The function calling module 108 calls programmatic functions to check if the input sentence maps against this standard. The function type includes checking whether the sentence contains abstract nouns or not.

The AI check module 114 utilizes the capabilities of advanced AI tools, such as ChatGPT, to analyze more details of the input sentence. By using an AI engine 118 like ChatGPT, Gemini, the AI check module 114 can understand complex linguistic patterns, contextual, and meanings that programmatic rules might not capture. The AI check module 114 sends the input sentence to the AI engine 118, along with a prompt that guides the model to evaluate whether the sentence conforms to the language standard. For example, the AI check module 114 might ask the AI engine 118 to determine if a sentence effectively uses passive voice or maintains a specific tone. The response from the AI engine 118 helps the AI check module 114 to decide if the sentence maps correctly to the standard.

An exemplary prompt provided by the AI check module to guide the AI engine 118 to check for the punctuation marks in the given input sentence and tag the sentence accordingly is given below:

```
  {
      “standard_id”: “L.5.2.a”,
      “description”: “Use punctuation to separate items in a
series.”,
      “functions_to_satisfy”: “any”,
      “functions”: [
        {
          “function_type”: “check_if_list”,
          “metadata”: null
        },
        {
          “function_type”: “run_AI”,
          “metadata”: {
            “model_name”: “gpt-3.5-turbo”,
            “system_prompt”: “You are a grammar expert and
educational expert. You are a fantastic curriculum and grammar expert.”,
            “user_prompt”: “Does the following sentence use
punctuation to separate items in a series? Reply either ‘Yes' or
‘No’.\n\n{sentence}”,
            “true_response”: “Yes”,
            “false_response”: “No”
          }
        }
      ],
      “positive_cases”: [
        “I packed my bag with a notebook, a pair of glasses, and a
pencil.”,
        “For dinner, I love to have pasta, fresh salad, garlic
bread, and perhaps a scoop of vanilla ice cream for dessert.”,
        “The blueprint for success includes hard work, persistence,
resilience, and a dash of good luck.”,
        “She was a famous personality, known for her expressive
eyes, charming smile, radiant beauty, and her immense talent in acting.”,
        “She was a famous, cool, nice, etc.”
      ],
      “negative_cases”: [
        “The sun set beneath the horizon, painting the sky with
hues of fiery red and soft pink.”,
        “Her favorite book inspired her to start writing her very
own non-fiction novels.”,
        “Despite the challenges he faced, the pioneer continued to
explore uncharted territories.”,
        “After graduation, she looks forward to visiting Rome, the
city filled with ancient history and rich culture.”
      ]
    }
```

The NLP check module 116 calls on established NLP libraries 120 to conduct analysis. The NLP check module 116 can use tools like spaCy, NLTK, or other natural language processing frameworks to perform tasks such as tokenization, part-of-speech tagging, syntax parsing, and semantic analysis. SpaCy provides features such as tokenization, part-of-speech tagging, named entity recognition, making it suitable for tasks ranging from basic text analysis to complex machine learning applications. Additionally SpaCy is built for performance and scalability, enabling the handling of large volumes of text quickly and for seamless integration with other machine learning frameworks. There are other NLP libraries available in Python such as Natural Language Toolkit (NLTK). Though SpaCy and NLTK are powerful libraries used in Python, the use of NLP libraries is not limited to Python programming language only. There are NLP libraries 120 used in other programming languages as well.

The NLP check module 116 helps in identifying grammatical structures, sentence components, and semantic relationships within the input sentence. For example, an NLP check module 116 might assess if the sentence maintains subject-verb agreement or follows proper noun phrase structures.

An example of a standard ‘L.3.1.c’ along with its definition and functions are shown below:

```
  {
    “standard_id”: “L.3.1.c”,
    “description”: “Use abstract nouns (e.g., childhood)”,
    “functions_to_satisfy”: “all”,
    “functions”: [
      {
        “function_type”: “check_words_exist”,
        “metadata”: {
          “list_of_words”: [“childhood”, “justice”, “love”, “bravery”,
...]
        }
      }
    ],
    “positive_cases”: [
      “My childhood was filled with sunny days and laughter.”,
      “Bravery is not the absence of fear, but the strength to confront
it.”
    ],
    “negative_cases”: [
      “The orange cat lazily prowled through the garden.”,
      “This morning, I ate a hearty breakfast.”
    ]
}
```

This example shows that for a sentence to qualify for the standard ‘L.3.1.c’, it must satisfy ‘all’ functions defined under this standard. The function included here is ‘check_words_exist’ and a list of words is also provided.

Together, these modules work in conjunction to provide a comprehensive analysis of the input sentence. The programming check module 112 applies deterministic rules, the AI check module 114 handles context-sensitive evaluation using AI engine 118, and the NLP check module 116 covers linguistic processing tasks using the NLP library 120. By combining the strengths of these different approaches, the ensures that the input sentence is accurately mapped to the language standard, and if all checks confirm the mapping, the sentence is tagged accordingly.

The code to call the function is explained in detail in U.S. patent application Ser. No. 19/367,655, which incorporated by reference in its entirety.

The function calling module 108 calls the JSON file from the mapping function library 104 using an API (not shown in the figure). The application programming interface enables the programmatic check module 112, the AI check module 114, and the NLP check module 116 to request program functions, the AI engine 118, and the NLP library 120 to map the input sentence with that of the first language standard respectively.

In operation 208, an educational standard mapping function module 110 executes the first set of functions to identify the mapping of the input sentence with the first set of the language standard.

The educational standard mapping function module 110 is integrated within the educational standard mapping system 106. The educational standard mapping function module 110 is operatively coupled to the function mapping module 108. Based on the input sentence matching the educational standard mapping function module 110 executes the first set of functions. The AI check module 114 calls receives the called functions from the function calling module 108 and passes them to the AI engine 118. The AI engine 118 is operatively coupled to the AI check module 114. The AI engine 118 checks if the input sentence maps the first standard. The AI checks are carried out for complex sentences including sentences to have ‘subordinating conjunctions’, ‘compound sentences’, complex sentences, etc.

The programmatic check module 112 calls for programmatic functions to check the mapping of input sentences. The programmatic functions can be used to check punctuation, simple sentences, etc. Similarly, the NLP check module 116 integrates with the NLP library 120. The NLP library 120 is a SpaCy library that is used to analyze sentences that use simple verb sentences, including subordinating conjunctions.

The educational standard mapping function module 110 executes all the set of functions that are called using the function calling module 108. For the input sentence to map against a particular standard, the input sentence should satisfy all the functions mentioned in the JSON file.

Below is an exemplary entry in the JSON file:

```
“standard_id”: “L.5.2.c.2”,
      “description”: “Use a comma to set off a tag question from the rest of
the sentence (e.g., It's true, isn't it?)”,
      “functions_to_satisfy”: “all”,
      “functions”: [
        {
            “function_type”: “ends_in_string”,
            “metadata”: {
              “string”: “?”
          }
        },
        {
            “function_type”: “contains_string”,
            “metadata”: {
              “string”: “,”
            }
        },
        {
          “function_type”: “run_AI”,
            “metadata”: {
              “model_name”: “gpt-4”,
              “system_prompt”: “You are a grammar expert and educational
expert. You are a fantastic curriculum and grammar expert.”,
              “user_prompt”: “Does the following sentence use a comma to
set off a tag question from the rest of the sentence? Reply either ‘Yes' or
‘No’.\n\nExample: It's true, isn't it? Yes\n\n{sentence}”,
              “true_response”: “Yes”,
              “false_response”: “No”
            }
        }
      ],
      “positive_cases”: [
        “The concert was amazing, wasn't it?”,
        “You're coming to the party, right?”,
        “It's going to rain today, don't you think?”,
        “She's the best basketball player in our school, wouldn't you
agree?”
    ],
      “negative_cases”: [
        “The moon is a beautiful sight at night.”,
        “Maria loves to bake cookies for her family during the holiday
season.”,
        “Despite the rain, we decided to continue our hiking trip, armed
with waterproof jackets and a strong sense of adventure.”,
        “Having a pet not only brings joy but also teaches children about
responsibility and empathy.”
      ]
  },
```

The JSON file contains the functions to be executed to map the input sentence against a specific sentence. The JSON file includes different sections including standard ID, description, functions to satisfy, and the functions.

The function calling module 108 calls the first set of functions for the standard ID ‘L.5.2.c.2’. The input sentence to be mapped is ‘It's true, isn't it?’. The first set of functions is a programmatic check including the function that the input sentence should end with a ‘?’. The educational standard mapping function module 110 executes a programmatic check to identify if the input sentence contains a ‘?’ in the end.

The second set of functions includes a “function_type”: “contains_string”, “metadata”: {, “string”; “,” which is a programmatic check to check if the input sentence contains a ‘,’. If the input sentence passes the second set of functions, then the educational standard mapping function module 110 executes the third set of functions.

The third set of functions includes a function_type”: “run_AI”, wherein the AI check module 114 provides a prompt to the AI engine 118 to respond if the input sentence maps against that function. The AI engine 118 utilizes the GPT to respond based on the prompts given by the AI check module 114.

In operation 210, the educational standard mapping function module 110 tags the input sentence with the first language standard if the executed functions confirm the mapping of the input sentence with the first language sentence, The input sentence is then passed for mapping against the next set of educational standards to generate an output sentence including the list of educational standards against which the input sentence is mapped.

The educational standard mapping system 106 finally tags the input sentence if the input sentence matches the first language standard. The input sentences are then stored in the tagged sentences 122 database which can be further accessed by the user. The tagged sentences 122 can be used in an online learning platform. If the student is using the online learning platform, the tagged sentences 122 can be used.

The sentence database 102 is periodically updated with new sentences to maintain relevancy and accuracy. This periodic update ensures that the sentence database 102 can accommodate newly identified or revised educational standards, which may emerge due to evolving educational guidelines, changes in curriculum frameworks, or advancements in research. By regularly adding new sentences, the educational standards alignment system 100 can keep up with shifts in language usage and maintain comprehensive coverage across a wide array of standards. This helps in expanding the sentence database 102 to include diverse sentence structures, examples, and variations, enhancing the ability of the educational standards alignment system 100 to tag input sentences accurately and effectively over time.

In one embodiment, the educational standards alignment system 100 is designed to call one or more functions from the mapping function library 104 to determine if an input sentence can be accurately tagged with a specific language standard. These functions are selected based on predefined criteria that outline the necessary conditions a sentence must meet to be considered as aligning with the standard. For instance, the criteria might specify that the sentence should follow a particular grammatical rule, include certain punctuation, or adhere to specific syntactic structures. Depending on the complexity of the standard, the function calling module 108 can either call at least one function (if a single check suffices) or require all functions in the set to execute (ensuring a more comprehensive evaluation) or multiple functions to execute.

In another embodiment, the educational standards alignment system 100 also incorporates a mechanism wherein the functions can include a list of one or more specific words that are essential for tagging the input sentence according to the language standard. This means that, for a sentence to be tagged, may need to contain at least one word from this predefined list. For instance, if a language standard pertains to using transition words to show contrast (e.g., “however,” “nevertheless,” “although”), the educational standard mapping function module 110 would check if the input sentence includes at least one of these words. By doing so, the educational standard mapping function module 110 ensures that the tagged sentences are not only structurally correct but also semantically aligned with the language standard. This word-based checking helps in verifying the presence of key terms that are critical for fulfilling the educational or grammatical criteria defined by the language standard.

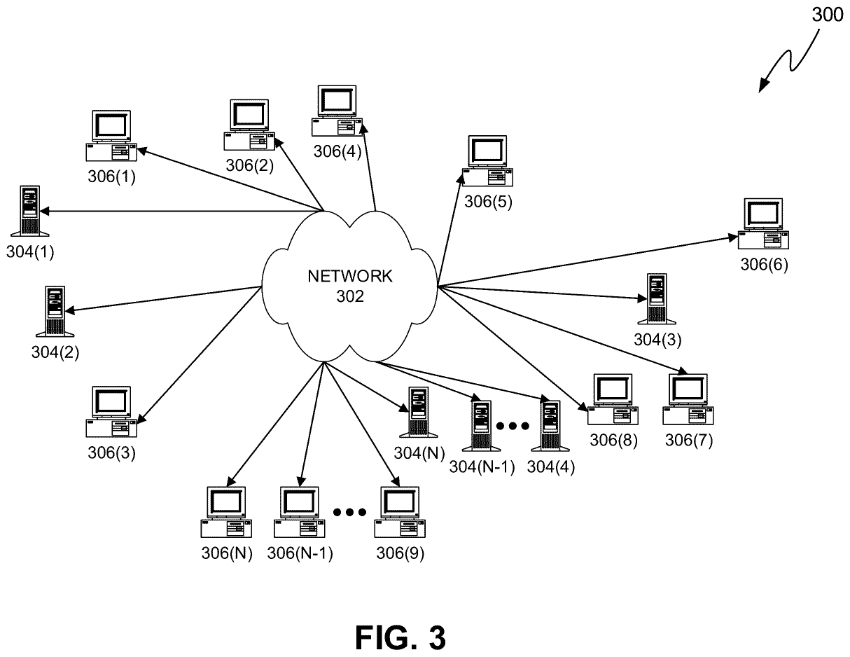

FIG. 3 is a block diagram illustrating a network environment in which an educational standards alignment system 100 and educational standards alignment process 200 may be practiced. Network 302 (e.g. a private wide area network (WAN) or the Internet) includes a number of networked server computer systems 304(1)-(N) that are accessible by client computer systems 306(1)-(N), where N is the number of server computer systems connected to the network. Communication between client computer systems 306(1)-(N) and server computer systems 304(1)-(N) typically occurs over a network, such as a public switched telephone network over asynchronous digital subscriber line (ADSL) telephone lines or high-bandwidth trunks, for example communications channels providing T1 or OC3 service. Client computer systems 306(1)-(N) typically access server computer systems 304(1)-(N) through a service provider, such as an internet service provider (“ISP”) by executing application specific software, commonly referred to as a browser, on one of client computer systems 306(1)-(N).

Client computer systems 306(1)-(N) and/or server computer systems 304(1)-(N) are specialized computer programmed to improve conventional computer systems to implement and utilize the educational standards alignment system 100 and educational standards alignment process 200. The type of computer system that can be specially programmed to implement and utilize the educational standards alignment system 100 and educational standards alignment process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the educational standards alignment system 100 and educational standards alignment process 200 can be implemented using code stored in a tangible, non-transient computer readable medium and executed by one or more processors. In at least one embodiment, the educational standards alignment system 100 and educational standards alignment process 200 can be implemented completely in hardware using, for example, logic circuits and other circuits including field programmable gate arrays.

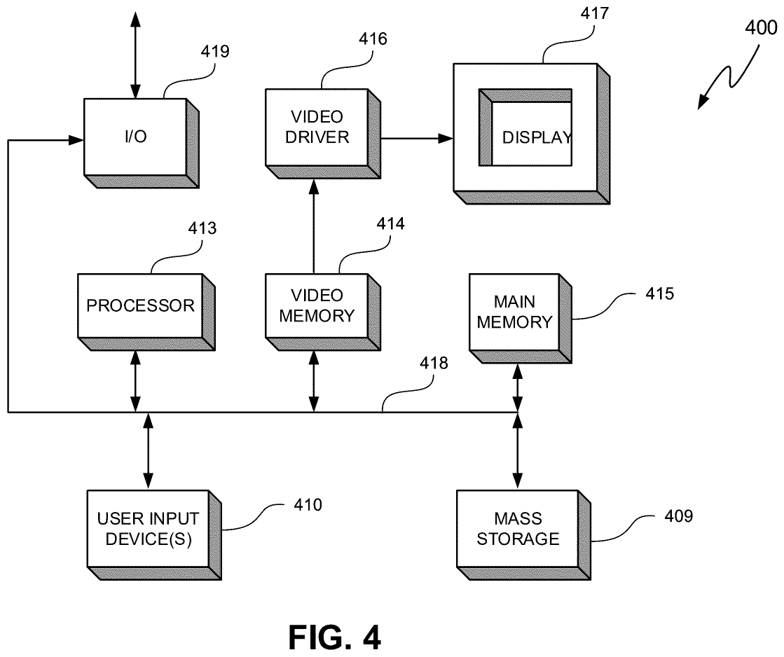

Embodiments of the educational standards alignment system 100 and educational standards alignment process 200 can be implemented on a computer system such as a special-purpose, special-programmed computer 400 illustrated in FIG. 4. Input user device(s) 410, such as a keyboard and/or mouse, are coupled to a bi-directional system bus 418. The input user device(s) 410 are for introducing user input to the computer system and communicating that user input to processor 413. The computer system of FIG. 4 generally also includes a non-transitory video memory 414, non-transitory main memory 415, and non-transitory mass storage 409, all coupled to bi-directional system bus 418 along with input user device(s) 410 and processor 413. The mass storage 409 may include both fixed and removable media, such as a hard drive, one or more CDs or DVDs, solid state memory including flash memory, and other available mass storage technology. Bus 418 may contain, for example, 32 of 64 address lines for addressing video memory 414 or main memory 415. The system bus 418 also includes, for example, an n-bit data bus for transferring DATA between and among the components, such as CPU 409, main memory 415, video memory 414 and mass storage 409, where “n” is, for example, 32 or 64. Alternatively, multiplex data/address lines may be used instead of separate data and address lines.

I/O device(s) 419 may provide connections to peripheral devices, such as a printer, and may also provide a direct connection to a remote server computer system via a telephone link or to the Internet via an ISP. I/O device(s) 419 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 409, into main memory 415 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 413, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 415 is comprised of dynamic random-access memory (DRAM). Video memory 414 is a dual-ported video random access memory. One port of the video memory 414 is coupled to video amplifier 416. The video amplifier 416 is used to drive the display 417. Video amplifier 416 is well known in the art and may be implemented by any suitable means. This circuitry converts pixel DATA stored in video memory 414 to a raster signal suitable for use by display 417. Display 417 is a type of monitor suitable for displaying graphic images.

The computer system described above is for purposes of example only. The educational standards alignment system 100 and educational standards alignment process 200 may be implemented in any type of computer system or programming or processing environment. It is contemplated that the educational standards alignment system 100 and educational standards alignment process 200 might be run on a stand-alone computer system, such as the one described above. The educational standards alignment system 100 and educational standards alignment process 200 might also be run from a server computer systems system that can be accessed by a plurality of client computer systems interconnected over an intranet network. Finally, the educational standards alignment system 100 and educational standards alignment process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for automatically calling one or more functions for checking if an input sentence maps against a language standard comprising:
executing codes using one or more processors of a computer system to cause the computer system to perform operations comprising:
receiving the input sentence from a sentence database, wherein the sentence database stores a list of sentences each aligning with one or more educational standards;
accessing a mapping function library including one or more set of functions, wherein each set of functions includes one or more functions to be executed to check mapping of the input sentence against an individual language standard;
calling a first set of functions from the mapping function library to check the mapping of the input sentence with a first language standard from the one or more educational standards, wherein the first set of functions include at least one or more of programmatic checks, AI checks, and NLP checks;
executing the first set of functions to identify mapping of the input sentence with the first set of language standard; and
tagging the input sentence with the first language standard if the executed functions confirm mapping of the input sentence with the first language standard, wherein the input sentence is then passed for mapping against the next set of educational standards to generate an output sentence including list of educational standards against which the input sentence is mapped.

2. The method of claim 1 wherein the list of functions is stored in a JSON file format in the mapping function library, such that the file includes definitions of educational standards and associated mapping functions.

3. The method of claim 1 wherein the educational standards include Common Core English Language Arts (CCELA) standards.

4. The method of claim 1 wherein each function includes a unique identifier showing its relation to a language standard such that the functions are executed to check if a received input sentence maps against the respective educational standards.

5. The method of claim 1 wherein the mapping function library includes the one or more functions specifically designed for identifying grammatical usage, punctuation usage, and semantic meaning within the input sentence.

6. The method of claim 1 further comprises:
calling an NLP library, a programming module check, an AI engine;
executing one or more functions to identify matching educational standards for the input sentences; and
providing a list of matching standards as an output.

7. The method of claim 1 wherein the programmatic checks in the first set of functions include regular expressions to identify specific patterns in the input sentence.

8. The method of claim 1 wherein the AI checks utilize the AI engine to provide context evaluation of complex sentence structures that cannot be processed by programmatic checks alone.

9. The method of claim 1 wherein the NLP checks involve tokenization, and part-of-speech tagging to analyze the input sentence.

10. The method of claim 1 wherein at least one or all the functions are called to satisfy the predefined criteria designed to check the tagging of the input sentences in the educational standards.

11. The method of claim 1 wherein the one or more functions also includes a list of one or more words, out of which at least one word is to be included in the language standard to be tagged.

12. The method of claim 1 wherein the sentence database is periodically updated with new sentences to ensure coverage of newly identified educational standards.

13. A system for automatically calling one or more functions for checking if an input sentence maps against a language standard comprising:
one or more processors of a computer system;
memory, coupled to the one or more processors, that store code and execution of the code by the one or more processors causes the computer system to perform operations comprising:
receiving the input sentence from a sentence database, wherein the sentence database stores a list of sentences each aligning with one or more educational standards;
accessing a mapping function library including one or more set of functions, wherein each set of functions includes one or more functions to be executed to check mapping of the input sentence against an individual language standard;
calling a first set of functions from the mapping function library to check the mapping of the input sentence with a first language standard from the one or more educational standards, wherein the first set of functions include at least one or more of programmatic checks, AI checks, and NLP checks;
executing the first set of functions to identify mapping of the input sentence with the first set of language standard; and
tagging the input sentence with the first language standard if the executed functions confirm mapping of the input sentence with the first language standard, wherein the input sentence is then passed for mapping against the next set of educational standards to generate an output sentence including list of educational standards against which the input sentence is mapped.

14. The system of claim 13 wherein the educational standards include Common Core English Language Arts (CCELA) standards.

15. The system of claim 13 wherein the one or more functions are stored in a JSON file format in the mapping function library, such that the file includes definitions of educational standards and associated checking functions.

16. The system of claim 13 wherein the one or more functions also includes a list of one or more words, out of which at least one word is to be included in the language standard to be tagged.
